(19) United States
(12) Patent Application Publication
(10) Pub. No.: US 2010/0310196 A1
(43) Pub. Date: Dec. 9, 2010

(54) SLIDER PROVIDED WITH URGING SPIGOTS

(75) Inventor: Antony Roger, Sartrouville (FR)

Correspondence Address: BIRCH STEWART KOLASCH & BIRCH, PO BOX 747, FALLS CHURCH, VA, 22040-0747, US

(73) Assignee: S2F FLEXICO, Henonville (FR)

(21) Appl. No.: 12/745,529

(22) PCT Filed: Nov. 28, 2008
(86) PCT No.: PCT/EP08/66474

§ 371 Date: Aug. 3, 2010

(30) Foreign Application Priority Data
Dec. 4, 2007 (FR) 0759545

(51) Int. Cl. B65D 33/16; B31B 49/04

(52) U.S. Cl. 383/64; 493/374

(57) ABSTRACT

The invention particularly relates to a slider (1) for actuating closure profiles (P₁, P₂), in particular for a closing assembly on a bag (S), that includes a base (10), two flanges (11, 12), and means adapted for respectively urging said closure profiles (P₁, P₂) towards each other or away from each other, depending on the slider movement direction along the profiles (P₁, P₂), in order to move the profiles (P₁, P₂) between a closed latched position and an open separated position, as well as protruding urging spigots (4) on said flanges (11, 12) in the vicinity of the end thereof opposite said base (10) in order to temporarily open the same and facilitate the engagement thereof onto said profiles (P₁, P₂) when a force is applied on said spigots (4). The slider is characterised in that said means includes means for receiving protrusions (T₁, T₂) associated with said profiles.

The invention relates to the field of bags provided with mating closure profiles, actuated by a slider.

It more specifically relates to a slider provided with urging spigots, to a bag equipped with the latter, a closure assembly with mating profiles, to a device and a method for its placement.

Many bags with mating closure profiles equipped with sliders have already been proposed.

Certain of the appended figures represent an exemplary slider according to the state of the art.

More specifically:

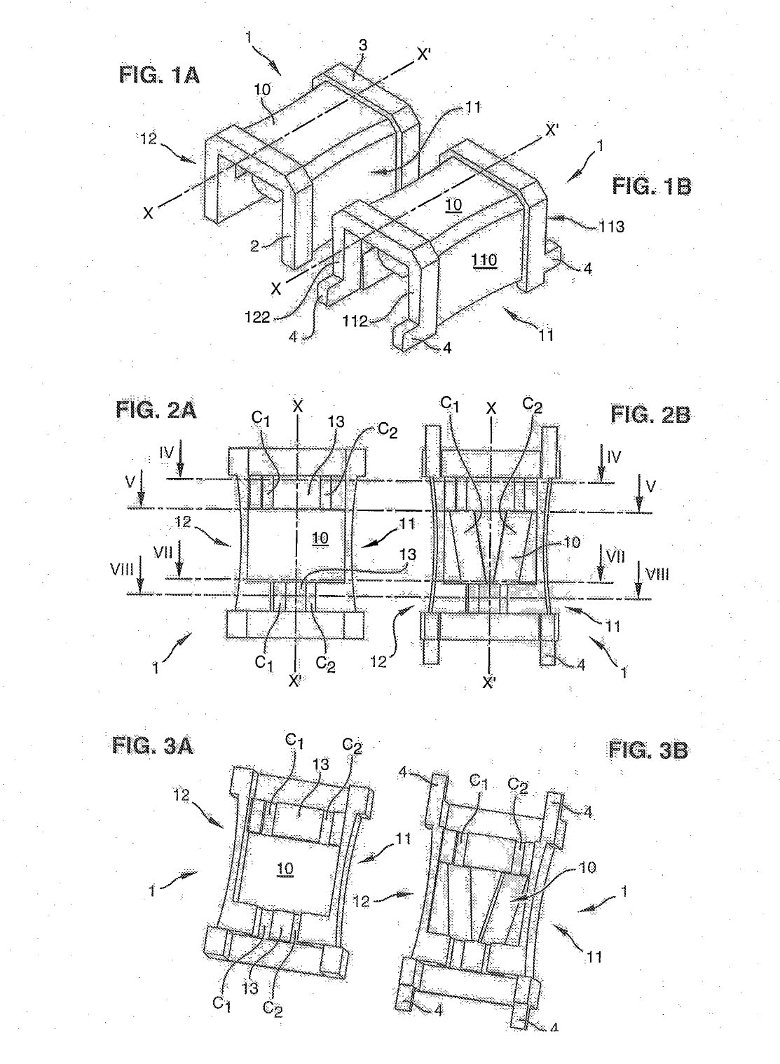

FIG. 1A is a perspective view of such a slider;

FIG. 2A is a bottom view of this slider;

FIG. 3A is an analogous view to the previous one slightly in perspective;

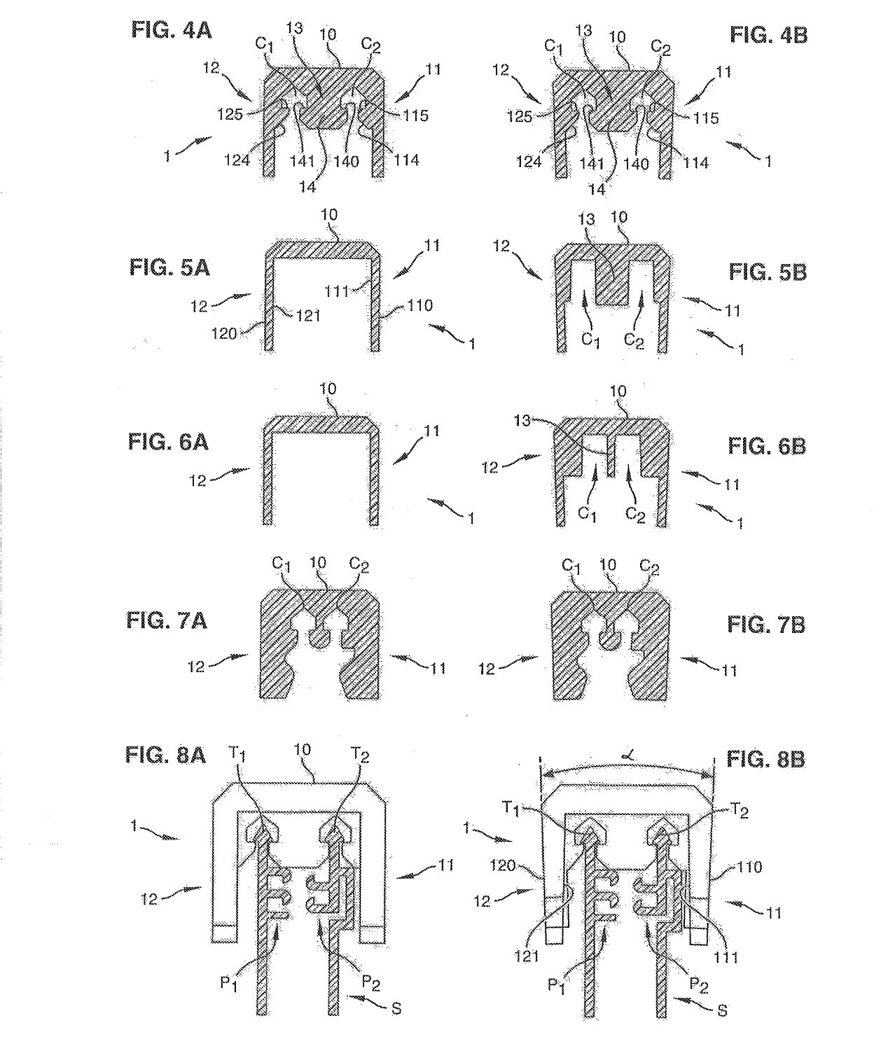

FIGS. 4A, 5A, 6A and 7A are respectively sectional views of the slider of FIG. 2A, along the planes IV-IV, V-V, VI-VI and VII-VII of this figure;

FIG. 8A is a view at the end of the slider of FIG. 1A.

In these figures, the profiles with which the slider is intended to cooperate have only been illustrated in FIG. 8A, in order not to unnecessarily burden the other figures.

Such a slider is made in molded plastic material and has a generally known structure.

More specifically, this slider has a section in the form of an inverted “U”, and includes a base 10 to which are connected two side wings 11 and 12 called “flanks”. The longitudinal axis of the slider is designated as X-X′, which corresponds to its displacement direction when it is installed on a bag with mating profiles. The flanks extend parallel to this axis.

In the aforementioned figures, the outer and inner faces of the flank 11 are referenced as 110 and 111, while the inner and outer faces of the flank 12 bear references 120 and 121.

Essentially for reasons of rigidity, the opposite ends of the slider 1 are conformed as arches 2 and 3 with a larger thickness than the remainder of its body.

Of course, in an embodiment not shown, this thickness may be identical over the whole extension of the slider.

In a well-known way per se, the inner space of the slider contains suitable means for urging mating closure profiles of a bag (localized as P₁, P₂ and S in FIG. 8A, respectively), either by bringing them closer or by moving them apart depending on the displacement direction of the slider along these profiles. By the expression “inner space” is meant the space delimited by the base 10 and the flanks 11 and 12.

In this case, these means comprise a longitudinal rib 13 which extends along the middle plane X-X′ of the slider.

This rib 13, made in the same material as the inner face of the base 10, separates the inner space into two corridors C₁ and C₂.

As shown more specifically by FIGS. 4A and 8A, the rib extends downwards through an elongated central sole 14 which juts out on either side of the rib 13 in order to form the guiding facets 140 and 141 of a protrusion T₁, T₂, here in the form of an arrow tip, located above an associated closure profile P₁, P₂ (see FIG. 8A). Each facet is turned towards the base 10. By “protrusion” is meant any means associated with the corresponding profile, which allows the slider to cooperate with the bag.

Moreover, the inner faces 111 and 121 of the flanks 11 and 12 each bear facing the sole 14, a projection 114, respectively 124, which is also provided with a facet 115, respectively 125, for guiding a protrusion.

The corridors C₁ and C₂ are therefore delimited by the base 10, the rib 13 and its associated sole 14, the inner faces of the flanks 11 and 12 and their associated projections 114 and 124. In other words, the corridors C₁ and C₂ have the shape of grooves with converging edges.

As this appears in FIGS. 2A and 3A, the corridors C₁ and C₂ only extend over a portion of the longitudinal extent of the slider, in this case in proximity to each of its opposite ends.

Moreover, the corridors C₁ and C₂ are closer to each other from a longitudinal end, so as to allow the profiles P₁, P₂ to be moved apart from each other or brought closer to each other depending on whether it is desired to close or open the relevant bag S. This particularity is clearly visible in FIGS. 2A and 3A, as well as by comparing FIGS. 4A and 7A.

Such is the structure of a slider according to the state of the art.

Such a slider therefore has to be placed on a bag S for which the two webs are provided with mating enclosure profiles.

The technique generally applied for doing this globally consists of deforming the slider so as to momentarily move its flanks 11 and 12 away from each other, bringing the profiles closer together in order to “surround” the latter, and then of bringing the flanks back to their initial position.

In application FR-A-2 667 225 of the present applicant, two longitudinal ribs are provided on the base of the slider, which are used, during their urging, for moving the flanks away from each other in order to open the passage corridors and allow mating engagement of the profiles.

This solution however does not give total satisfaction when the slider has a large thickness.

Indeed, under these conditions, the generated lever arm is not very significant, and the flanks do not deform as well as this would be desirable.

Further, the urging for opening the flanks is accomplished simultaneously with the pushing of the slider towards the profiles, which requires perfect coordination of these operations.

In document U.S. Pat. No. 6,584,666, a slider is described which is able to provide a solution to the problem stated above. This slider comprises protruding urging spigots on its flanks, in the vicinity of the end opposite to the base of the slider, in order to temporarily open it and facilitate its engagement on profiles, when urging is exerted on the spigots.

A first goal of the invention is to further enhance this type of slider, notably as regards its cooperation with the closure profiles.

A secondary goal of the invention is to propose a device and a method for placing the slider which simplifies the setting-up of the latter.

The invention therefore relates to a slider for actuating closure profiles, notably for a closure assembly fitting out a bag, comprising one base, two flanks, suitable means for respectively urging said closure profiles, either by bringing them closer together or moving them apart depending on the displacement direction of the slider along the profiles, in order to displace the profiles between a closure initiation position and a separate opening position, as well as protruding urging spigots on said flanks, in the vicinity of the end of the latter opposite to said base, in order to temporarily open it and facilitate its engagement on said profiles when urging is exerted on said spigots, characterized by the fact that said means comprise means for receiving protrusions associated with said profiles.

According to other advantageous and non-limiting features of this slider:
the large outer faces of said flanks are slightly convergent towards their end opposite to said base;
the angle α formed by said large outer faces is of the order of 4°;
the angle β formed by said facet and the associated wall of said rib is less than 90°;
the angle β formed by said facet and the inner face of said flank is less than 90°;
said angle β is of the order of 85°;
an intermediate portion of said corridors has a profile such that they ensure the guiding of said profiles during its placement of the slider on the profiles, so that once the slider is assembled, these channel profiles are then without any contact or practically without any contact with the latter.

The invention also relates to a bag comprising a closure assembly with mating profiles, provided with a slider for actuating said profiles upon opening and closing according to one of the previous features.

The object thereof is also a closure assembly with mating profiles, provided with a slider for actuating said profiles upon opening and closing, according to one of the previous features.

It also relates to a device for placing such a slider, on a bag with mating closure profiles or on a closure assembly with mating profiles, which comprises at least one retaining clamp in a stable position of the profiles.

This device is remarkable in that it also includes means for pushing a slider towards means for temporarily moving said flanks of the slider away from each other in order to have it cooperate with said profiles, these means for moving them away comprising cam paths with an upward slope capable of cooperating with said spigots.

Advantageously, said cam paths have a smaller longitudinal extension than the course of said slider, so that after having crossed the cam paths, the flanks of said cursor return to their initial position.

Preferentially, said cam paths are borne by said clamp.

Finally the invention relates to a method for placing such a slider on a bag, by means of clamps, the opposite faces of which bear cams with an upward slope. This method is characterized in that it comprises the steps consisting of:
opening the jaws of each clamp and engaging therein the edge of the bag provided with mating profiles;
tightening the jaws in order to immobilize the bag;
pushing said slider towards the bag, so that its spigots engage onto the cams and ensure the separation of its flanks, until the spigots jut out from said cams and are no longer urged, which causes engagement of the slider onto the profiles.

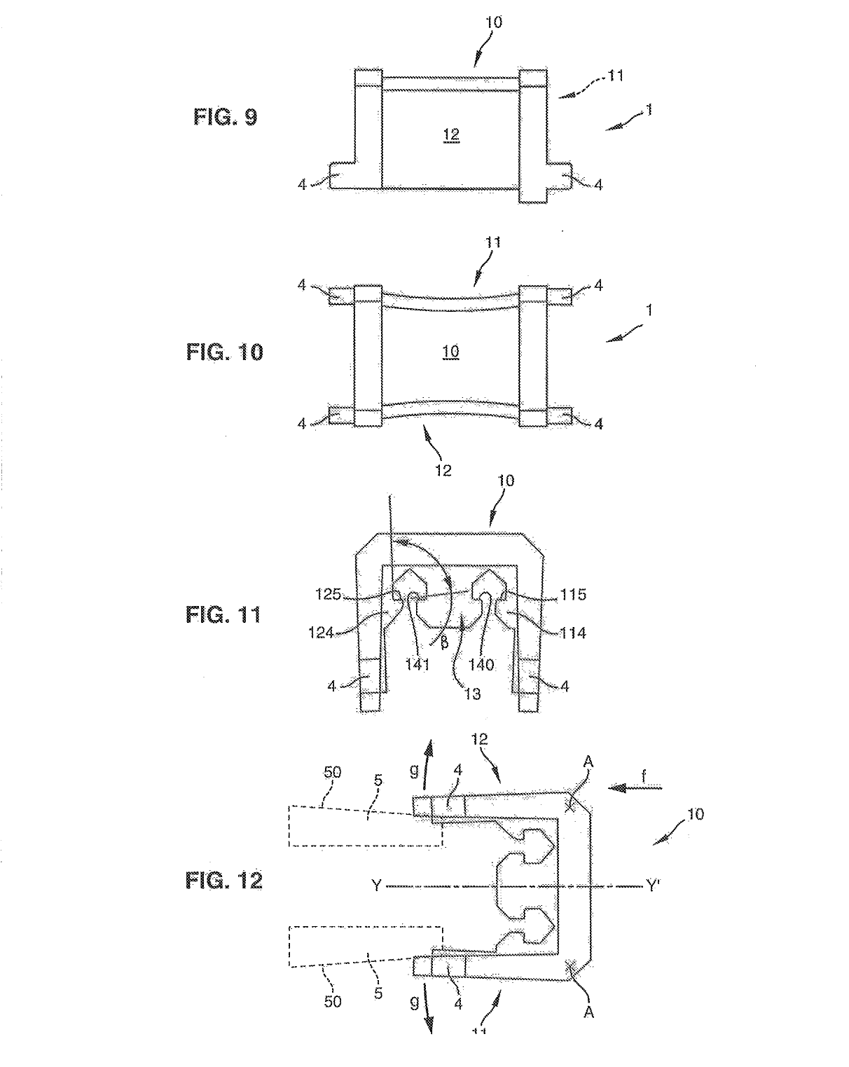

Other features and advantages of the present invention will become apparent upon reading the description which follows of a preferential embodiment. This description will be given with reference to the appended drawings and more specifically by referring to FIGS. 1B-8B, which are analogous to FIGS. 1A-8A on which comments were made above, as well as to the additional FIGS. 9 to 13G wherein:

FIG. 9 is a side view of a slider according to the invention;

FIG. 10 is a top view of the slider of FIG. 9,

FIG. 11 is a view at the end of this slider;

FIG. 12 is a diagram showing, according to an end view, the slider of the previous figures, in connection with the cam paths which will allow the flanks to be moved apart;

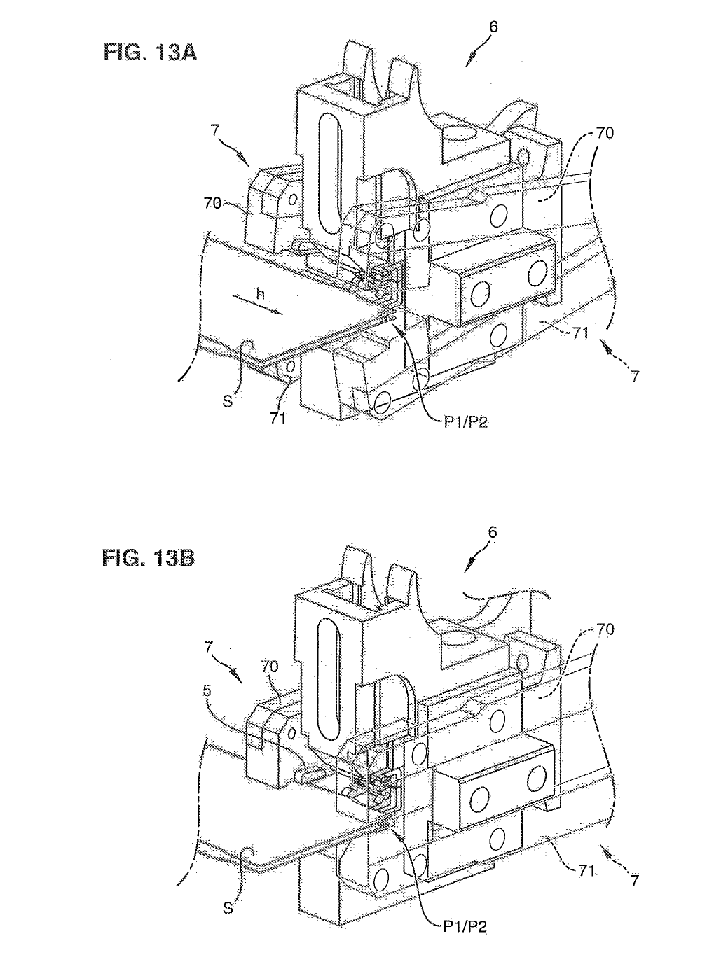

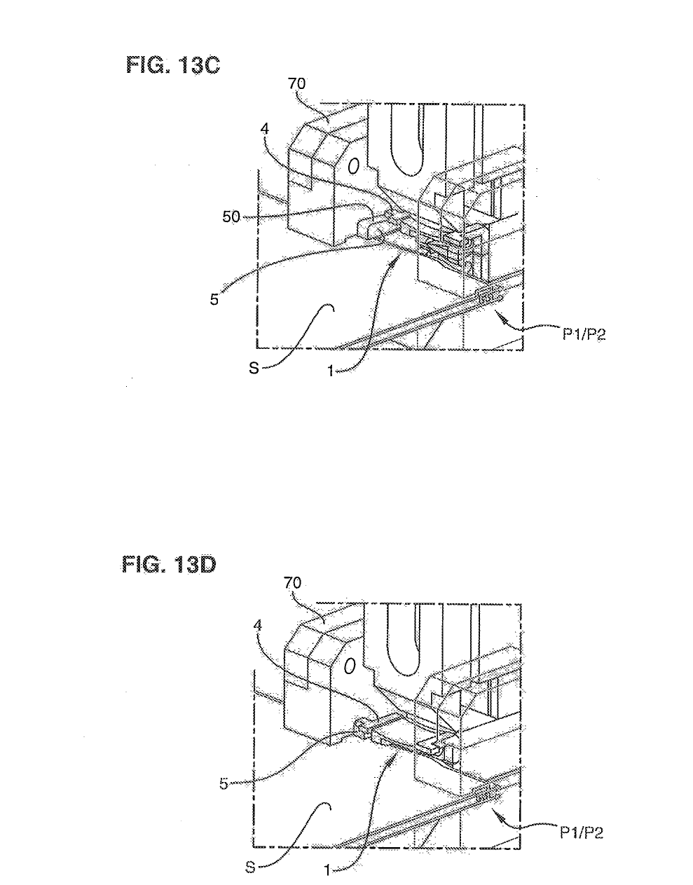

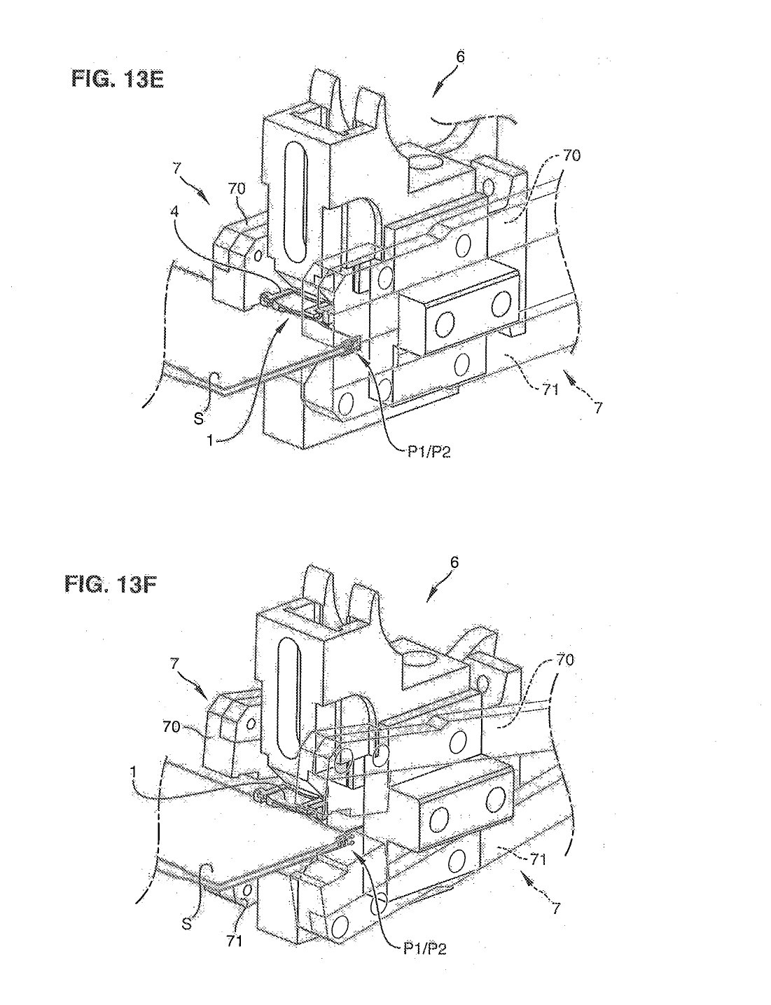

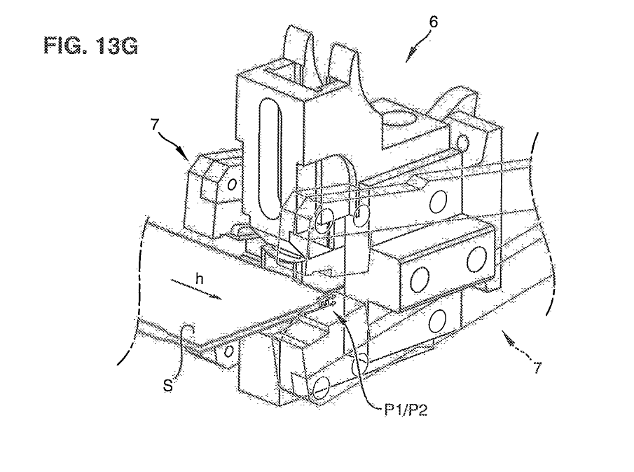

FIGS. 13A-13G are diagrams showing a device for placing a slider such as the one of the previous figures, on a bag with mating closure profiles, these different figures illustrating the main placement steps.

The exemplary slider according to the invention, which is illustrated on the figures announced above, substantially has the same general structure as the one which is described earlier, with reference to the state of the art (FIGS. 1A-8A).

Therefore, we shall limit ourselves essentially to the description of the differences which the slider of the invention has relatively to the state of the art. In the figure specific to the invention, references identical to those already used designate the same elements.

As announced, the slider 1 of FIGS. 1B-8B includes protruding urging spigots 4 on the flanks 11 and 12, in the vicinity of the end of the latter, which is opposed to the base 10, in order to temporarily open and facilitate its engagement onto mating profiles, either associated or not to a bag, when urging is exerted on these spigots 4.

How this urging is exerted will be described later on in the description.

More specifically, in the appended figures, the spigots 4 have the shape of rectangular parallelepipeds and are made in the same material as the slider. They extend on the opposite edges 112 and 122 of the flanks 11 and 12 along the axis X-X′.

A spigot is provided on the edge of each flank. And these spigots are placed in the vicinity of the free end of the flanks.

Finally, and as this is visible notably in FIG. 2B, the spigots 4 transversely have a thickness identical with that of the edges 112 and 122. However, this thickness may be more reduced or thicker.

Referring to FIG. 8B, it is noticed that the large outer faces 110 and 120 of the flanks 11 and 12 are slightly convergent towards their free end, opposite to the base 10. In the example illustrated here, the angle α formed by these large outer faces is of the order of 4°.

The advantage of such a feature will be explained later on.

Now considering FIGS. 2B and 7B, it is noticed that the corridors C₁ and C₂ are present over the whole of the longitudinal extension of the slider.

More specifically, in the intermediate region of the profile, these corridors C₁ and C₂ with converging edges have a channel profile, so that they may ensure the guiding of the mating profiles during the placement of the slider on the profiles. Once the slider is assembled, these channel profiles are then without any contact, or practically without any contact with the mating profiles.

Now referring to FIG. 11, it is noticed that the facets 115 and 140 on the one hand and 141 and 125 on the other hand form, with the associated walls of the ribs 13 and flanks 11 and 12, an angle β of slightly less than 90°. This angle is for example of the order of 85°.

Such an orientation of the facets will form an element for fastening and retaining the protrusions T₁, T₂ associated with the profiles P₁, P₂ of the bag S, thereby improving the withdrawal resistance of the slider.

This is particularly useful for example when dealing with children who grab the bag and attempt to remove the slider by putting the latter in their mouth.

For placing such a slider on mating profiles either associated or not with a bag, as in the state of the art, it will be sought to move the flanks 11 and 12 apart so as to temporarily “open” the corridors C₁ and C₂ so as to be able to position said protrusions therein.

To do this and as schematically illustrated in FIG. 12, use will be made of cam pairs 5 having opposite outer faces 50 forming cam paths with an upward slope, and the slider will be displaced towards these cam paths in the direction of the arrow f, so that the spigots 4 will be supported thereon.

It is understood that from the moment that the displacement in the direction of the arrow f is continued, the flanks 11 and 12 move away from each other in the direction of the arrows g, by a corner effect.

The arrangement of the spigots 4 on the end of the flanks 11 and 12 allows a much larger deformation torque to be applied than the one obtained with ribs conventionally placed on the top of the slider, the lever arm relatively to the pivotal area illustrated by reference A of FIG. 12 being longer. In this way, deformation of the flanks is easier, which simplifies the installation of the slider on a bag.

With the ribs located on the top of the sliders, their urging upon opening is accomplished simultaneously with the translational thrust of the slider towards the profiles.

On the contrary, according to the invention, the urging upon opening the sliders and the thrust may be decoupled.

Reference will now be made to FIGS. 13A-13G in order to illustrate the placement of such a slider on a bag S provided with mating profiles P₁ and P₂.

It is clear that this description is also valid for placing a slider on profiles P₁ and P₂ not yet associated with a bag. In this case, these assemblies are the ones which are displaced in the direction of the arrow h.

The bag is part of a strip of contiguous bags, which are displaced stepwise, in order to equip them in turn with a slider. The displacement direction is illustrated by the arrow h in FIGS. 13A and 13G.

Conventionally, such a device 6 includes a pair of parallel clamps 7, the upper jaws of which are referenced as 70, while the lower jaws are referenced as 71.

In a way known per se, this device comprises means (not visible) for supplying sliders and pushing these sliders towards the bag to be equipped.

In this case, these means are positioned halfway between the aforementioned jaws 7.

A first step of this placement, shown in FIG. 13A, consists of opening the jaws 70 and 71 of each clamp 7 so as to be able to engage therein the edge of the bag provided with mating profiles P₁ and P₂.

In a second step, the jaws 70 and 71 are tightened onto each other (FIG. 13B) so as to immobilize the bag S. In FIG. 13B the aforementioned cams 5 are clearly visible, which are borne by the faces opposite the jaws 70 and 71 of the clamps 7.

In a third step illustrated in FIG. 13C, the slider 1 is pushed towards the bag S, so that its urging spigots 4 engage onto the paths 50 of the cams 5.

The upward configuration of these cam paths cause the flanks 11 and 12 to gradually move apart when, simultaneously, the pushing means mentioned above bring the slider 1 closer to the bag S.

This pushing movement is such that the slider is found exactly facing the profile, the spigots 4 have then moved beyond the cam paths 50 and are no longer urged. They then tend to find their initial position again.

This is the situation of FIG. 13E. The slider is then found engaged on the profiles P₁ and P₂.

In a subsequent step, it is proceeded with moving the jaws 70 and 71 of the clamps 7 apart. This is the situation of FIG. 13F.

Finally, the strip of bags is displaced for placing a slider on a new bag (FIG. 13G).

It will be noted that the particular orientation (angle α) of the outer faces of the flanks 11 and 12 as illustrated in FIG. 8 allows, when the flanks return to their initial position, compensation of the fact that this return is not accomplished entirely, the flanks tending to occupy a position slightly set back relatively to their starting position.

To summarize, the method according to the invention comprises the steps of:
opening the jaws of each clamp and engaging therein the edge of the bag provided with mating profiles;
tightening the jaws in order to immobilize the bag;
pushing said slider towards the bag, so that its spigots engage onto the cams and ensure separation of its flanks, until the spigots jut out from said cams and are no longer urged, which causes engagement of the slider onto the profiles.

1-13. (canceled)

14. A slider for actuating closure profiles, notably for a closure assembly fitting out a bag comprising a base, two flanks, suitable means for respectively urging said closure profiles by bringing them closer together or by moving them apart depending on the direction of displacement of the slider along the profiles, in order to displace the profiles between a closure initiation position and a separate opening position, as well as protruding urging spigots on said flanks in the vicinity of the end of the latter, opposite to said base, in order to temporarily open it and facilitate its engagement on said profiles when urging is exerted on said spigots, wherein said means comprise means for receiving protrusions associated with said profiles.

15. The slider according to claim 14, wherein the large outer faces of said flanks are slightly convergent towards their end opposite to said base.

16. The slider according to claim 15, wherein the angle α formed by said large outer faces is of the order of 4°.

17. The slider according to claim 14, the suitable means for respectively urging said closure profiles by bringing them closer to each other or moving them apart depending on the direction of displacement of the slider along the profiles, for displacing the profiles between a closure initiation position and a separate opening position, comprising a longitudinal rib which subdivides at least one portion of its inner space into two corridors, this rib extending through a sole which juts out on either side of said rib in order to form facets for guiding a protrusion, wherein the angle β formed by said facet and the associate wall of said rib is less than 90°.

18. The slider according to claim 17, wherein the inner face of each of the flanks includes a longitudinal projection which delimits an edge of one of said corridors, this projection including a facet for guiding a protrusion, and wherein the angle β formed by said facet and the inner face of said flank is less than 90°.

19. The slider according to claim 17 or 18 as a combination, wherein angle β is of the order of 85°.

20. The slider according to claim 14, the suitable means for respectively urging said closure profiles by bringing them closer or moving them apart depending on the direction of displacement of the slider along the profiles, for displacing the profiles between a closure initiation position and a separate opening position, comprising a longitudinal rib which subdivides at least one portion of its inner space into two corridors, wherein an intermediate portion of said corridors has a profile so that they ensure guidance of said profiles during its placement of the slider on the profiles, so that once the slider is assembled, these channel profiles are then without any contact or practically without any contact with the latter.

21. A bag comprising a closure assembly with mating profiles, provided with a slider for actuating said profiles upon opening and closing according to claim 14.

22. A closure assembly with mating profiles, comprising a closure assembly with mating profiles provided with a slider for actuating said profiles upon opening and closing according to claim 14.

23. A device for placing a slider according to claim 14, on a bag with mating closure profiles or on an assembly of mating closure profiles, wherein it comprises at least one clamp for retaining profiles in a stable position, as well as means for pushing a slider towards means for temporarily moving said flanks away from the slider in order to have it cooperate with said profiles, these means for moving them apart comprising cam paths with an upward slope capable of cooperating with said spigots.

24. The device according to claim 23, wherein said cam paths have a smaller longitudinal extent than the course of said slider, so that after having crossed the cam paths, the flanks of said slider return to their initial position.

25. The device according to claim 23, wherein said cam paths are borne by said clamp.

26. A method for placing a slider on a bag with mating closure profiles, this slider comprising a base, two flanks and suitable means for respectively urging said closure profiles by bringing them closer or moving them apart depending on the direction of displacement of the slider along the profiles, for displacing the profiles between a closure initiation position and a separate opening position, as well as protruding urging spigots on said flanks in the vicinity of the end of the latter, opposite to said base, in order to temporarily open it and facilitate its engagement onto said profiles when urging is exerted on said spigots by means of clamps, the faces of which opposite the jaws bear cams with an upward slope, wherein said method comprises the steps of:
opening the jaws of each clamp and engaging therein the edge of the bag provided with mating profiles;
tightening the jaws for immobilizing the bag;
pushing said slider towards the bag so that its spigots engage onto the cams and ensure separation of its flanks, until the spigots jut out from said cams and are no longer urged, which causes engagement of the slider onto the profiles.
